(19) United States
(12) Patent Application Publication
(10) Pub. No.: US 2016/0171447 A1
(43) Pub. Date: Jun. 16, 2016

(54) METHODS AND SYSTEMS FOR PROVIDING PROMOTIONAL VIDEO

(71) Applicant: Travis Reep, Matthews, NC (US)

(72) Inventor: Travis Reep, Matthews, NC (US)

(21) Appl. No.: 14/969,194

(22) Filed: Dec. 15, 2015

Related U.S. Application Data
(60) Provisional application No. 62/092,221, filed on Dec. 15, 2014.

(51) Int. Cl. G06Q 10/10; H04N 21/254; H04N 21/2543; G06Q 50/00; H04N 21/658; H04N 21/475; G06Q 20/12; H04N 21/4627; H04N 21/4788

(52) U.S. Cl. CPC G06Q 10/1053; H04N 21/4627; H04N 21/2541; H04N 21/2543; H04N 21/4788; H04N 21/6582; H04N 21/4753; G06Q 20/127; G06Q 50/01

(57) ABSTRACT

A computer system and implemented method for distributing job application video includes: receiving an applicant's identifying information and creating an applicant account; receiving a video of an applicant and associating the video with the applicant account; indexing the video of the applicant and adding the applicant's identifying information to a searchable database for third party viewers, wherein the third party viewers are registered; providing the third party viewers access to the video of the applicant upon request by the applicant and/or the third party viewer; and tracking third party views of the video and updating a status of the applicant account with each third party view.

### CROSS-REFERENCE TO RELATED APPLICATIONS

To the full extent permitted by law, the present United States Non-provisional patent application hereby claims priority to and the full benefit of United States Provisional application entitled “Methods and Systems for Providing Promotional Video,” having assigned Ser. No. 62/092,221, filed on Dec. 15, 2014, incorporated herein by reference in its entirety.

### FEDERALLY SPONSORED RESEARCH OR DEVELOPMENT

None

### PARTIES TO A JOINT RESEARCH AGREEMENT

None

### REFERENCE TO A SEQUENCE LISTING

None

### BACKGROUND OF THE DISCLOSURE

1. Technical Field of the Disclosure

The present disclosure relates generally to job applications, resumes and information provided to human resources prior to the interview/hiring process. More specifically, the instant disclosure relates to methods and systems for providing promotional video prior to the interview/hiring process.

2. Description of the Related Art

Organizations that employ or contract with large numbers of people likely use a human resources or procurement function that, among other tasks, receives applications from interested job seekers or vendors. Typically, a large part of job applications are in the form of resumes that contain a summary or listing of relevant job experiences and education that highlight reasons why a potential recruit should be hired. In this regard, an important role of the human resources function is to choose, from an applicant pool, which applicants to interview, and eventually, which ones to hire.

Therefore, it is readily apparent that there is a recognizable unmet need for additional methods and systems for providing applicant information prior to the interview/hiring process.

### SUMMARY

Embodiments are directed to computer implemented methods for distributing job application video, comprising: receiving an applicant's identifying information and creating an applicant account; assigning the applicant a unique identification number based on applicant's information; receiving a video of an applicant, wherein the applicant provides an introduction to be viewed by a potential employer, and associating the video with applicant's account; indexing applicant's video and adding applicants information to a searchable database for third party users; providing third party viewers access to applicant's video upon request by application and/or third party viewer; and tracking viewers of the video and updating status of account with each view. The system may provide an example video to assist applicant in preparing content and format. Once a video is uploaded applicant can supply contact information such as cell phone or email. In certain aspects a subscription charge will be associated with upload. The subscription charge can be paid in the form of an autopay via credit card or intermediary (e.g., Pay Pal). In certain aspects an option may be provided to push a charge to a viewer. In a further aspect there is an option for applicant to pay per view of the video or to pre-purchase a designated number of views. In select embodiments, the video may be not more than 10, 15, 20, 25, or 30, seconds or up to 1, 2, 3, 4, or 5 minutes in length. In select embodiments, the video can be approximately 15-30 seconds long. In other select embodiments, the video can be approximately 3 minutes long. In certain aspect the third party viewer is registered with the system. In other aspects a security option may be provided to limit the amount of views and or duration the video may be viewed and/or may limit or prevent certain third parties from viewing the video. For example, the applicant may limit or may only purchase their video to be viewed 4 times and/or for five days and then it will not be available for viewing.

Other embodiments are directed to a system, comprising: at least one processor; and a memory coupled to the at least one processor, the memory configured to store program instructions executable by the at least one processor to cause the system to: receive an applicant's identifying information and create an applicant account; assign the applicant a unique identification number based on applicant's information; receive a video of an applicant, wherein the applicant provides an introduction to be viewed by a potential employer, and associating the video with applicant's account; index applicant's video and add applicants information to a searchable database for third party users; providing third party viewers access to applicant's video upon request by application and/or third party viewer; and track viewers of the video and update status of account with each view.

Other embodiments of the invention are discussed throughout this application. Any embodiment discussed with respect to one aspect of the invention applies to other aspects of the invention as well and vice versa. Each embodiment described herein is understood to be embodiments of the invention that are applicable to all aspects of the invention. It is contemplated that any embodiment discussed herein can be implemented with respect to any method or composition of the invention, and vice versa. Furthermore, compositions and kits of the invention can be used to achieve methods of the invention.

The use of the word “a” or “an” when used in conjunction with the term “comprising” in the claims and/or the specification may mean “one,” but it is also consistent with the meaning of “one or more,” “at least one,” and “one or more than one.”

Throughout this application, the term “about” is used to indicate that a value includes the standard deviation of error for the device or method being employed to determine the value.

The use of the term “or” in the claims is used to mean “and/or” unless explicitly indicated to refer to alternatives only or the alternatives are mutually exclusive, although the disclosure supports a definition that refers to only alternatives and “and/or.”

As used in this specification and claim(s), the words “comprising” (and any form of comprising, such as “comprise” and “comprises”), “having” (and any form of having, such as “have” and “has”), “including” (and any form of including, such as “includes” and “include”) or “containing” (and any form of containing, such as “contains” and “contain”) are inclusive or open-ended and do not exclude additional, un-recited elements or method steps.

Other objects, features and advantages of the present invention will become apparent from the following detailed description. It should be understood, however, that the detailed description and the specific examples, while indicating specific embodiments of the invention, are given by way of illustration only, since various changes and modifications within the spirit and scope of the invention will become apparent to those skilled in the art from this detailed description.

### DESCRIPTION OF THE DRAWINGS

The following drawings form part of the present specification and are included to further demonstrate certain aspects of the present invention. The invention may be better understood by reference to one or more of these drawings in combination with the detailed description of the specification embodiments presented herein. As such, the present methods and systems for providing promotional video will be better understood by reading the Detailed Description with reference to the accompanying drawings, which are not necessarily drawn to scale, and in which like reference numerals denote similar structure and refer to like elements throughout, and in which:

FIG. 1 is an illustration of exemplary embodiments of some of the functionalities of devices in communication via communications interface with the system for providing promotional video according to the instant disclosure.

FIG. 2 is a block diagram of an exemplary embodiment of the computer system configured to implement various systems and methods for providing promotional video described herein according to select embodiments.

FIG. 3 is an illustration of an exemplary embodiment of the system used to implement the system and methods for providing promotional video described herein according to select embodiments.

### DESCRIPTION

Certain embodiments are directed to a method or system for obtaining, providing, and/or managing videos or recorded introductions of a person seeking a position, a job, an internship, admittance, contract, or other opportunities for which a person will apply or be selected for. The video or recorded introduction is referred to herein as a “Video.” In certain aspects the Video is a promotional or self-promotional video. In a further aspect the Video is not more than 10, 15, 20, 25, or 30, seconds, or extended versions of up to 1, 2, 3, 4, or 5 minutes in length. In select embodiments, the Video can be approximately 15-30 seconds long. In other select embodiments, the Video can be an extended Video of approximately 3 minutes long. The Video can be created or provided by an applicant or a representative of an applicant. As used herein the “applicant” is the person or entity creating and/or providing a Video. A Video can be provided in various formats that are amenable to electronic transmission and storage, such as, but not limited to WebM, Matroska, Flash Video, F4V, Ogg, Dirac, MNG, AVI, QuickTime, WMV, RM, RMVB, ASF, MPEG-4, MPEG-1, MPEG-2, M4V, SVI, or 3GPP.

The Video can be utilized and managed by a computer system and/or a mobile device. The system or device will comprise a controller that can be configured to receive, transmit, and/or manage one or more Videos. In certain aspects the system utilizes a communication network and a server configured to assist in receiving, transmitting, or managing one or more Videos. The Video can be transmitted to a server where it can be received, stored, processed, and accessed for a period of time. In certain aspects the server is in communication with storage. In certain aspects the Video is transmitted to a server that is configured to receive the Video and any associated information, such as registration information, identification information, and the like. The Video is received by the server, processed as appropriate, and made available under various conditions to customers or third parties.

Once a Video has been processed and stored, a third party can be granted access to view the Video, or the Video may be sent to the third party. As used herein a third party viewing the Video is referred to as a “Viewer.” The Viewer is given the option of contacting the applicant or user that is the subject of the Video. The system may be configured to convey a message from the Viewer to the Applicant directly or indirectly. The system may also be configured to provide feedback to the Applicant or the Viewer. A Viewer can access the Video from a local or remote location. An interested party or Viewer may consist of anyone with an interest in viewing a Video, and can include, but is not limited to applicants, employers and employer representative(s), agents or applicant representative(s), vendors, and the like. The Viewer may view the Video via computer, phone, smart device, or software application. In certain aspects the Viewer is assessing employment or job qualifications and obtaining information about the applicant.

In certain embodiments, the server, after registering an Applicant, retrieves additional information related to the Applicant from websites and other publically available sources. In certain aspects, this public information is then combined with Applicant-submitted information and an Applicant's Video. The Video and applicant information is transmitted to storage and configured for retrieval by or transmission to or from the server when needed or requested.

In certain aspects the Applicant can initiate contact with a Viewer through the system. The Applicant can instruct the system to transmit all or part of Applicant's information. The information provided can be customized by the Applicant and can include one or more of employment history, education, mailing address, e-mail address, phone number, skills and experience, and a link to the Applicant's Video or a copy of the Applicant's Video. In certain aspects, the Applicant transmits a request to the system to provide Applicant's information to a Viewer or potential contact or employer via a communication interface. The recipient of the Applicant's Video can be in a database managed by the system. The system may provide a listing of open positions or a searchable database. In certain aspects the available positions may be provided to the Applicant anonymously. In certain aspects the Applicant communicates with the system via an interface. In certain aspects the Applicant interacts with the system via the internet, e.g., through a webpage(s). The Applicant may transmit the request from a device including a computer, phone, smart device, or software application. The device may be configured or programmed with an application that specifically interfaces with the system or the system can be accessed via a web browser. Upon receipt of the proper account information by the Applicant or Applicant's device, the system may then provide access or access instructions to Applicant's Video to the Viewer. In certain aspects, the Video is stored in the system. The system can store numerous individual Videos for numerous Applicant or user specific accounts. Applicant information in the system can be stored, secured, and maintained by the system. In certain aspects the Applicant's information or third party information can be categorized and indexed using numerous criteria allowing various types of searches to be performed. In certain aspects the Videos can be retrieved by category, such as geographical location or job experience.

In certain embodiments, the applicant can set up an account on the system. In certain aspects the Applicant accesses the system through a mobile device application or a website able to communicate with the system. In certain embodiments, a webpage presents an option to set up an Applicant or Customer account. Typically the account is used to provide security to the Applicant's information, communication with the Applicant and/or Customer, and management of the information in the system.

In certain aspects the Applicant establishes an account with the system and creates a record or account that is stored by the system. In certain aspects the Applicant enters his/hers/its full name. The Applicant may also enter other descriptors that identify Applicant in other internet based sites. In a further aspect the Applicant can link or import information on other sites such as LinkedIn and Facebook. The Applicant can also provide a geographical location, such as a state, in which the applicant wishes to post a Video. In certain aspects a questionnaire is provided to obtain information pertinent to the system. In certain aspects the Applicant accepts a terms-of-use disclaimer to proceed with set up. Upon creating an account, entering information, and accepting the terms of use, the system generates an identification number for the Applicant. The applicant may then use the identification number to access the Applicant's account, be uniquely identified by the system, and to provide Applicant information to a third party. The identification number may also be used to keep the identity of the Applicant confidential until such time as Applicant desires, or is required, to present his/hers/its identity.

In certain aspects a Video is generated by or uploaded to the system by the Applicant and is associated with the Applicant's account. The Applicant can review and edit the Video as needed; however, in certain situations the most recent Video or the Video designated for dissemination or viewing is the Video used by the system for transmission or viewing by a recipient. In further aspects the applicant may adjust the Video. In certain embodiments the system will be configured to require payment using an associated payment component of the system.

In certain embodiments, all or portions of the substance of the Video is drawn from information pulled from Applicant's informational and social media accounts on the Internet. Information can also be submitted directly by the Applicant to the system. In certain aspects, the Applicant may submit a resume to the system. In certain aspects the system provides for the recording of additional audio or a voiceover with the Video. The applicant can request that a voiceover of Applicant's resume be added to the Applicant's Video. In still further aspects applicant may request that a written description of application be made available concurrently or separately with a Video. Section(s) such as “skills” or “employment history” can be presented before, during or after the viewing of a Video. The written commentary can be integrated into the Video, i.e., visually depicted in the Video, or accompanying the Video as a separate document or link.

The system is configured to create, maintain, and manage a plurality of applicant accounts. The account can be updated by an Applicant. For example, the applicant may add funds or provide payment information to their account. The Applicant will be able to modify various settings and activity of an account. In certain embodiments the system monitors the viewing of a Video, either by the Applicant, Customer, or a third party. Based on the monitored viewing, the system will be configured to assign a cost to an account on the system or to request payment at the time of viewing. In certain aspects an Applicant, Customer, or registered third party can purchase credits or views that can be used as the purchaser sees fit. The system will account for and manage the credits or views or any other purchases mediated by the system. As such, options may be provided to limit the amount of views or duration that the video may be viewed, and/or may limit or prevent certain third parties from viewing the video. For example, the applicant may limit or may only purchase their video to be viewed four times and/or for five days and then it will not be available for viewing. In other aspects, the system may be configured to post, maintain, manage and track the videos not only on the system, but on other various locations and sites, including, but not limited to, social media sites, tools or applications, as well as any resume or video resume job board.

In certain embodiments the registration will be conducted in at least two phases. The first phase being a pre-registration phase in which an Applicant is given access to an account and provided an identification number, referred to herein as the pre-registration. Pre-registration allows an Applicant to submit a Video. The pre-registration will have minimal features enabled. In order to activate other features the Applicant will need to complete registration (phase two). Complete registration can include providing payment or charge information, address, phone number, email address, etc. The system will use this account information to contact the Applicant regarding the Applicant's registered account. In certain aspects the applicant may also choose to store payment information in the system. If payment information is stored, the applicant can consent to push charging in which the Applicant's account is automatically billed each time the Applicant's Video is viewed. By setting up push charging, the applicant ensures that the interested party viewing applicant's Video will not have to pay to view the Video.

In certain embodiments viewing of the Video by an interested party (Customer or third party) includes accessing the system by way of a communication interface, e.g., the Internet. An interested party can access the system by computer, phone, smart device, or software application (e.g., an App). In certain aspects when a Video is viewed by an interested party, the applicant's account is charged or the interested party must submit payment either directly or indirectly via a Customer account. An interested party may also be registered with the system, i.e., is a Customer, and will have its account set up appropriately for payment purposes. As examples, in select embodiments, the Applicant or Viewer can purchase 1 View at $1.99, the Applicant or Viewer may purchase 5 View Credits at $9.95, the Applicant or Viewer may purchase 10 View Credits (Get 1 FREE) at $17.91, and/or the Applicant or Viewer may purchase 15 View Credits (Get 2 FREE) at $25.87.

In other embodiments the system can provide an Applicant with reports including identity of viewer, date and time of viewing, number of views, etc. In certain aspects the system can provide an accounting and summary of account for each registered user. In other aspects the system can provide alerts regarding a number of aspects of the account, such as funding, credits, or views purchased. Each of the account components can be associated with a user preference or setting so that the user can customize the features of the system for the user's account. These customize setting are stored in the system and utilized in maintaining and servicing the account. The term servicing is used to refer to the various functions and process associated with operating, maintaining, and performing the functions of the system.

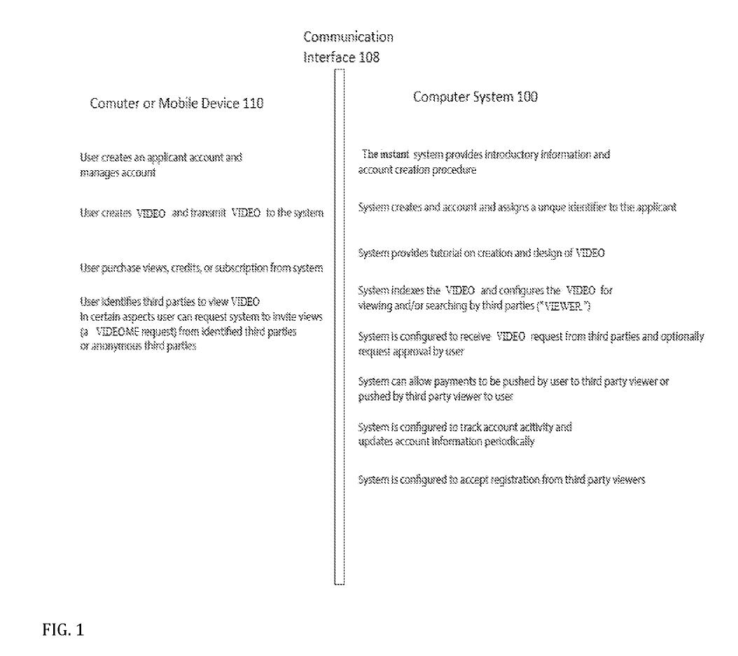

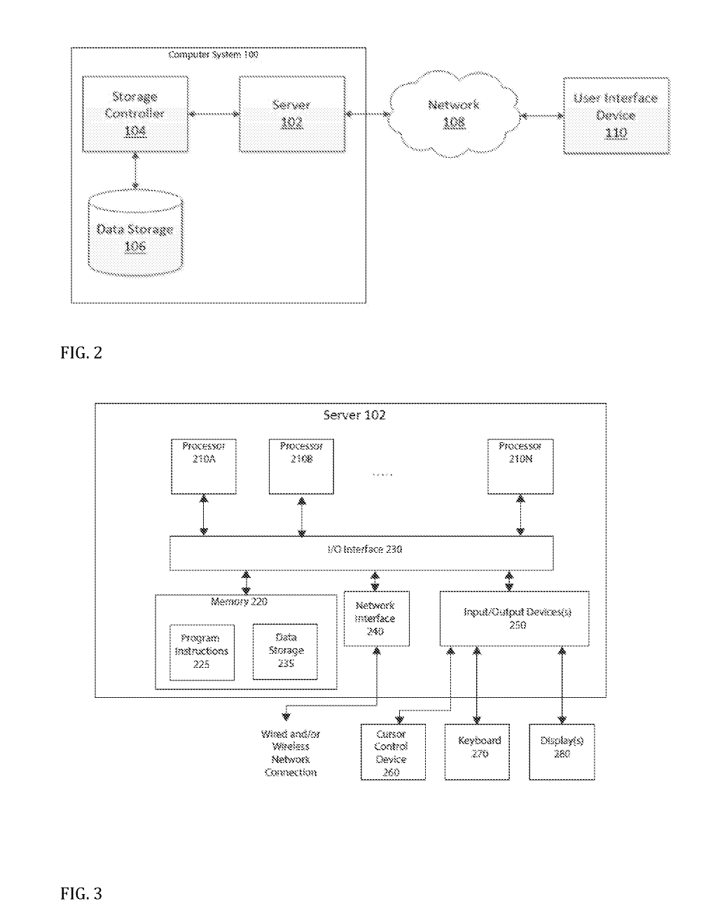

Referring now to FIGS. 1-3, select embodiments of system 100 are shown. System 100 may be implemented or executed by one or more computer systems. One such computer system is illustrated in FIG. 2. In various embodiments, computer system 100 may be a server, a mainframe computer system, a workstation, a network computer, a desktop computer, a laptop, or the like. For example, in some cases, a Video System may be implemented as computer system 100. Moreover, one or more of servers 102 or devices may include one or more computers or computing devices generally in the form of computer system 100. As explained above, in different embodiments various computer systems and/or devices may be configured to communicate with each other in any suitable way, such as, for example, via an internet network. Computer system 100 can comprise a server 102 coupled to storage controller 104 which is coupled to data storage 106. The computer system can be in communication with various user interface devices 110 via network 108.

As illustrated in FIG. 3, server 102 can include one or more processors 210 coupled to a system memory 220 via an input/output (I/O) interface 230. Computer system 202 may further include a network interface 240 coupled to I/O interface 230, and one or more input/output devices 250, such as cursor control device 260, keyboard 270, and display(s) 280. In some embodiments, a given entity (e.g., Video System) may be implemented using a single instance of server 102, while in other embodiments multiple such systems, or multiple nodes making up server 102, may be configured to host different portions or instances of embodiments. For example, in an embodiment some elements may be implemented via one or more nodes of server 102 that are distinct from those nodes implementing other elements (e.g., a first computer system may implement Glancing service while another computer system may implement accounting services).

In various embodiments, server 102 may be a single-processor system including one processor 210, or a multi-processor system including two or more processors 210 (e.g., two, four, eight, or another suitable number). Processors 210 may be any processor capable of executing program instructions. For example, in various embodiments, processors 210 may be general-purpose or embedded processors implementing any of a variety of instruction set architectures (ISAs), such as the x86, POWERPC®, ARM®, SPARC®, or MIPS® ISAs, or any other suitable ISA. In multi-processor systems, each of processors 210 may commonly, but not necessarily, implement the same ISA. Also, in some embodiments, at least one processor 210 may be a graphics-processing unit (GPU) or other dedicated graphics-rendering device.

System memory 220 may be configured to store program instructions and/or data accessible by processor 210. In various embodiments, system memory 220 may be implemented using any suitable memory technology, such as static random access memory (SRAM), synchronous dynamic RAM (SDRAM), nonvolatile/Flash-type memory, or any other type of memory. As illustrated, program instructions and data implementing certain operations, such as, for example, those described herein, may be stored within system memory 220 as program instructions 225 and data storage 235, respectively. In other embodiments, program instructions and/or data may be received, sent or stored upon different types of computer-accessible media or on similar media separate from system memory 220 or server 102. Generally speaking, a computer-accessible medium may include any tangible storage media or memory media such as magnetic or optical media—e.g., disk or CD/DVD-ROM coupled to server 102 via I/O interface 230. Program instructions and data stored on a tangible computer-accessible medium in non-transitory form may further be transmitted by transmission media or signals such as electrical, electromagnetic, or digital signals, which may be conveyed via a communication medium such as a network and/or a wireless link, such as may be implemented via network interface 240.

In an embodiment, I/O interface 230 may be configured to coordinate I/O traffic between processor 210, system memory 220, and any peripheral devices in the device, including network interface 240 or other peripheral interfaces, such as input/output devices 250. In some embodiments, I/O interface 230 may perform any necessary protocol, timing or other data transformations to convert data signals from one component (e.g., system memory 220) into a format suitable for use by another component (e.g., processor 210). In some embodiments, I/O interface 230 may include support for devices attached through various types of peripheral buses, such as a variant of the Peripheral Component Interconnect (PCI) bus standard or the Universal Serial Bus (USB) standard, for example.

Network interface 240 may be configured to allow data to be exchanged between server 102 and other devices attached to network 108, such as other computer systems, or between nodes of a computer system. In various embodiments, network interface 240 may support communication via wired or wireless general data networks, such as any suitable type of Ethernet network, for example; via telecommunications/telephony networks such as analog voice networks or digital fiber communications networks; via storage area networks such as Fiber Channel SANs, or via any other suitable type of network and/or protocol.

Input/output devices 250 may, in some embodiments, include one or more display terminals, keyboards, keypads, touch screens, scanning devices, voice or optical recognition devices, or any other devices suitable for entering or retrieving data by one or more computer system. Multiple input/output devices 250 may be present in a computer system or may be distributed on various nodes of computer system. In some embodiments, similar input/output devices may be separate from computer system and may interact with one or more nodes of computer system through a wired or wireless connection, such as over network interface 240.

As shown in FIG. 3, memory 220 may include program instructions 225, configured to implement certain embodiments described herein, and data storage 235, comprising various data accessible by program instructions 225. In an embodiment, program instructions 225 may include software elements of embodiments described herein. For example, program instructions 225 may be implemented in various embodiments using any desired programming language, scripting language, or combination of programming languages and/or scripting languages (e.g., C, C++, C#, JAVA®, JAVASCRIPT®, PERL®, etc). Data storage 235 may include data that may be used in these embodiments. In other embodiments, other or different software elements and data may be included.

A person of ordinary skill in the art will appreciate that computer system 100 and server 102 is merely illustrative and is not intended to limit the scope of the disclosure described herein. In particular, the computer system and devices may include any combination of hardware or software that can perform the indicated operations. In addition, the operations performed by the illustrated components may, in some embodiments, be performed by fewer components or distributed across additional components. Similarly, in other embodiments, the operations of some of the illustrated components may not be performed and/or other additional operations may be available. Accordingly, systems and methods described herein may be implemented or executed with other computer system configurations.

1. A computer implemented method for distributing job application video, comprising:
receiving an applicant's identifying information and creating an applicant account;
receiving a video of an applicant and associating the video with the applicant account;
indexing the video of the applicant and adding the applicant's identifying information to a searchable database for third party viewers;
providing the third party viewers access to the video of the applicant upon request by the applicant and/or the third party viewer; and
tracking third party views of the video and updating a status of the applicant account with each third party view.

2. The method of claim 1, wherein the indexing of the video includes categorizing and indexing using numerous criteria allowing various types of searches to be performed, wherein the video can be retrieved by category.

3. The method of claim 2, wherein the criteria categorized and indexed for the video include geographical location, job experience, or combinations thereof.

4. The method of claim 1 further comprising providing reports to the applicant including identity of third party viewers, date and time of viewing, number of views, or combinations thereof.

5. The method of claim 1 further comprising assigning the applicant a unique identification number based on applicant's information, where the unique identification number is used to access the Applicants account and can be utilized to keep the identity of the Applicant confidential until such time as Applicant desires, or is required, to present his/hers/its identity.

6. The method of claim 1 further comprising the applicant creating the video or a representative of the applicant providing the video, wherein the applicant provides an introduction to be viewed by a potential employer.

7. The method of claim 1 further comprising establishing an applicant subscription wherein payment is required.

8. The method of claim 1 further comprising giving the third party viewer the option of contacting the applicant of the video directly or indirectly.

9. The method of claim 8, wherein the third party viewer may contact the application to provide feedback to the Applicant.

10. The method of claim 1 further comprising giving the Applicant the option of contacting any or all of the third party viewers.

11. The method of claim 1 further comprising transmitting all or part of Applicant's identification information to third party viewers, wherein Applicant's identification information includes employment history, education, mailing address, e-mail address, phone number, skills and experience, or combinations thereof.

12. The method of claim 1, wherein all or portions of the substance of the video is drawn from information pulled from Applicant's informational and social media accounts on the Internet.

13. The method of claim 1 further comprising the Applicant submitting a resume along with the video.

14. The method of claim 1 further including the options of:
adding audio or a voiceover to the video;
including a written description of Application to be made available concurrently or separately with the video;
presenting resume sections before, during or after the viewing of a video, wherein the resume sections include skills, employment history, or combinations thereof; or
combinations thereof.

15. The method of claim 1, wherein the video of applicant is up to 3 minutes long, up to 30 seconds long, or up to 15 seconds long.

16. A system, comprising:
at least one processor; and
a memory coupled to the at least one processor, the memory configured to store program instructions executable by the at least one processor to cause the system to:
receive an applicant's identifying information and creating an applicant account;
receive a video of an applicant and associating the video with the applicant account;
index the video and add applicant's identifying information to a searchable database for third party viewers;
provide the third party viewers access to the video upon request by applicant and/or the third party viewer; and
track third party view of the video and update a status of the applicant account with each third party view.

17. The system of claim 16, wherein the indexing of the video includes categorizing and indexing using numerous criteria allowing various types of searches to be performed, wherein the video can be retrieved by category.

18. The system of claim 16, wherein the system is further caused to provide reports to the applicant including identity of third party viewers, date and time of viewing, number of views, or combinations thereof.

19. The system of claim 16, wherein the system is further caused to assign the applicant a unique identification number based on applicant's information, where the unique identification number is used to access the Applicants account and can be utilized to keep the identity of the Applicant confidential until such time as Applicant desires, or is required, to present his/hers/its identity.

20. The system of claim 16, wherein the system is further caused to give the third party viewer the option of contacting the applicant of the video directly or indirectly.
